(19) United States
(12) Patent Application Publication
(10) Pub. No.: US 2015/0159400 A1
(43) Pub. Date: Jun. 11, 2015

(54) TEMPORARY DOOR LOCK

(71) Applicant: Steven Seigler, Hampstead, NC (US)

(72) Inventor: Steven Seigler, Hampstead, NC (US)

(21) Appl. No.: 14/101,556

(22) Filed: Dec. 10, 2013

(51) Int. Cl. E05B 9/02; E05B 15/02; E05B 67/00; E05B 9/00

(52) U.S. Cl. CPC E05B 9/02; E05B 9/002; E05B 15/02; E05B 67/00

(57) ABSTRACT

A temporary door lock is described that includes a one-piece vertically aligned jamb plate including an attachment section attachable to the latch jamb and an outwardly projecting latch extension, having a front edge, an inner side away from, the door opening, and a hole sized to receive a padlock shackle, the attachment section and latch extension being in a common plane; and a latching member attached to the inner side of the latch extension, the latching member including a connector plate extending perpendicularly from the inner side of the vertical locking extension and a latching plate with a vertically elongated latch opening hinged to the connector plate and pivotal between an unlocked position away from the door and a locked position in which the latch extension extends through the latch opening and the latching plate extends into the pathway of the door preventing opening.

### FIELD OF THE INVENTION

The present invention relates to a temporary door lock for use in locking a door prior to the installation of door locking hardware or as an auxiliary lock, and in particular to a heavy duty temporary door lock that includes a jamb plate and a latching member attached to the jamb plate and pivotal to a locked position in front of a door where the latching member can be locked to the jamb plate.

### DESCRIPTION OF THE PRIOR ART

A temporary door lock is often required to prevent opening of a door where a permanent lock has not yet been installed, or where an auxiliary lock in addition to the permanent lock is required. For example, temporary door locks are frequently used during building construction, to secure a door before installation of a permanent lock.

While these temporary locks are of numerous configurations, a common design is screwed to the door jamb using the screw holes drilled for a strike plate. An example of this type of lock is shown in U.S. Design Patent No. 319, 964 to Johns. In the Johns lock, a first plate is screwed to the door jamb and then bends at a 90° angle around the front of the door frame to connect to a hinged locking plate that has an open position and a closed position. In the closed position, the distal end of the locking plate extends into the pathway of the door so that the door will contact the locking plate if opening of the door is attempted.

A horizontal eyelet for receiving the shackle of a padlock extends forward from the section of the jamb plate that is wrapped around the front of the door frame. A horizontal slot in the lunge plate fits over the eyelet when the hinge plate is in the closed position, so that the shackle of a padlock can inserted through the evict to prevent opening of the hinge plate. While the Johns lock is effective, there ate instances in winch a more robust lock is required.

The temporary lock described and claimed herein is designed for temporary attachment to a door frame to prevent opening of a door supported within the frame. The lock is normally used dining construction where a permanent, lock has not been installed, although other applications are contemplated.

Generally, the temporary lock is comprised of a jamb plate that is attached to the latch jamb of the door frame, i.e., the jamb side to which the strike plate of a permanent and open positions, and a locked position extending into the door pathway to prevent pivoting of the door to the open position. A padlock attachable to the jamb plate prevents lock will be attached, and a latch member including a latch plate that is designed to pivot between an unlocked position away the pathway in which, the door pivots between closed movement of the latching member from its closed position.

The vertically oriented jamb plate includes an attachment section and a latch extension that is integral with and extends in a common plane outwardly from the front of the attachment section perpendicular to the door frame. The attachment section and larch extension are preferably integrally formed from a single metal plate. The attachment section can include boles for insertion of screws to attach the jamb plate to the jamb. The screw holes may be spaced for alignment with holes predrilled for attachment of a strike plate of a permanent door lock.

The latch extension also includes at least one, preferably two, holes near its forward edge sized for insertion of the shackle of a padlock to prevent removal of the latch plate from the latch extension. In the preferred embodiment the latch extension height is less than the height of the connector plate, and has a width greater than the width of the attachment section.

As noted, the latch member includes a latch plate that is pivotal between at unlocked position out of the pathway in winch the door pivots and a locked position in with the latch plate extending into the door pathway so that the door will contact the latch plate to prevent opening the door. The latch member includes a connector plate that is attached to lire latch jamb side of the latch extension intermediate the jamb attachment section and the padlock hole or holes. The edge of the connector plate away from the latch jamb, i.e., toward the hinge jamb, is perpendicularly attached to the inner side of the latch extension, e.g., by welding.

The edge of the connector plate away from the latch extension is pivotally attached to the proximal edge of the latch plate. In the preferred embodiment, the joined edges of the connector plate and latch plate include intermeshed cylindrical knuckles, with a pin being inserted through the knuckles to form a hinge barrel similar to that of a butt hinge.

The latch plate includes a vertically elongated opening or slot sized for insertion over the end of the latch extension when the latch plate is moved to its closed position. The slot width is greater than the width of the latch extension so that the extension can be inserted by pivoting the latch plate. When the latch extension is fully inserted into the slot of the closed latch plate, the extension will be offset toward the latch side of the slot and the padlock holes will be in front of the latch plate enabling attachment of a padlock to prevent movement of the latch plate from its closed and locked position. Since the forward end of the latch plate extends into the pathway of the door, opening of the door is prevented. The latch plate may also include an additional hole or holes for receiving a padlock shackle for storage of the padlock when the lock is not used.

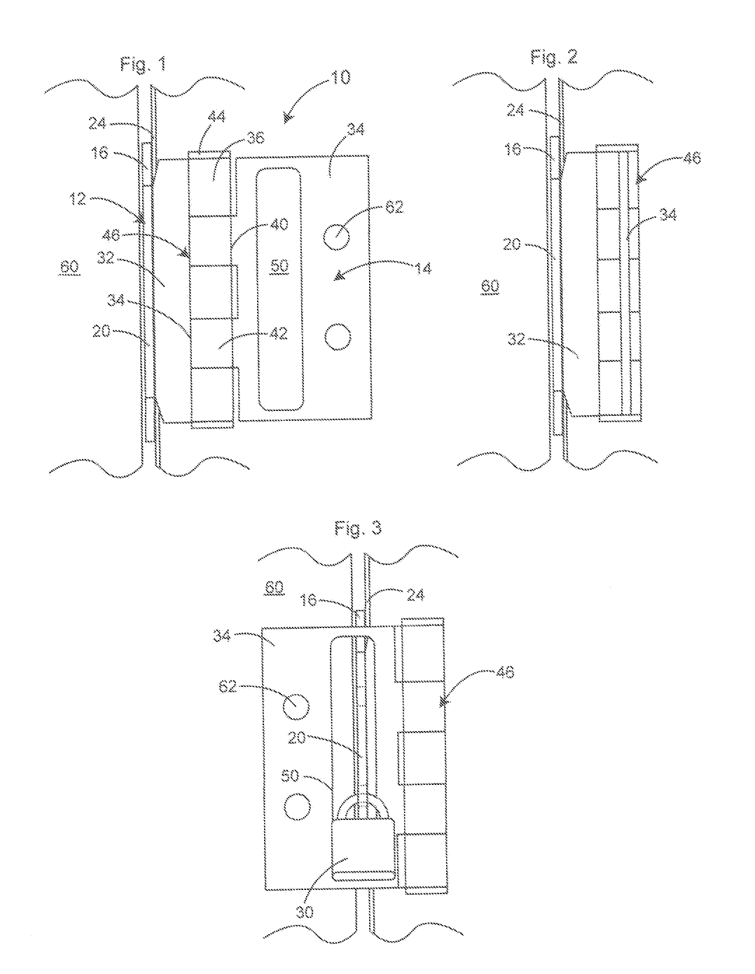

FIG. 1 is a front view of the lock with the lock in the fully unlocked position,

FIG. 3 is a front view of the lock with the lock in the full locked position.

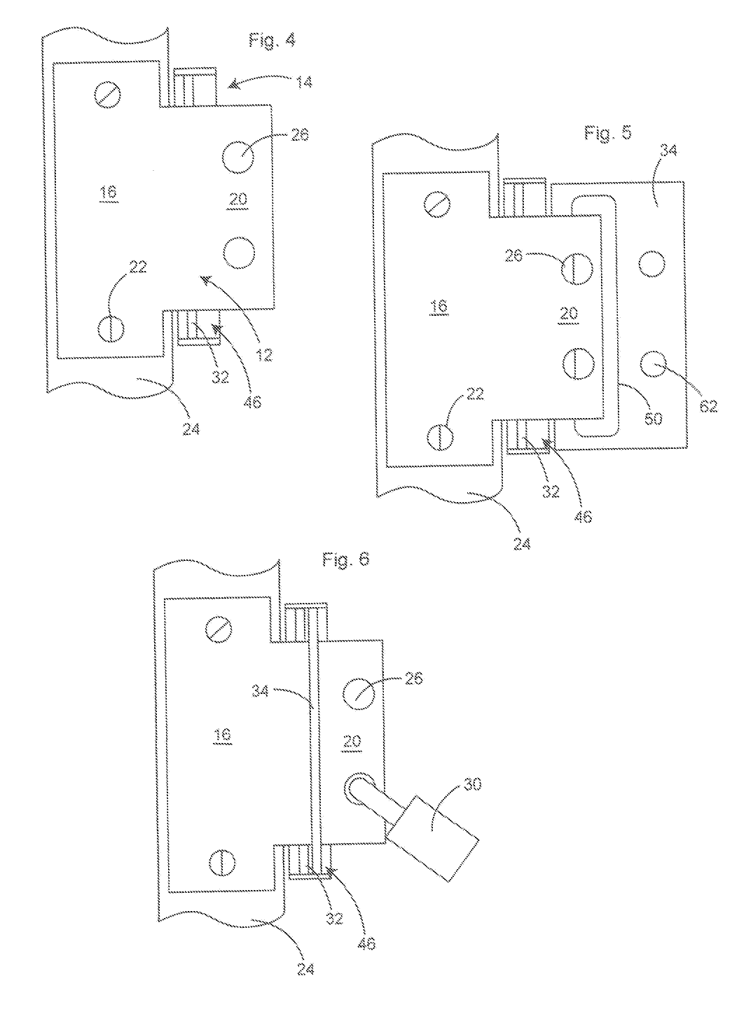

FIG. 4 is a side view of the lock with the lock in the fully unlocked position.

FIG. 5 is a side view of the lock with the lock in the partially unlocked position.

FIG. 6 is a side view of the lock with the lock in the full locked position,

FIG. 7 is a top view of the lock with the lock in the fully unlocked position.

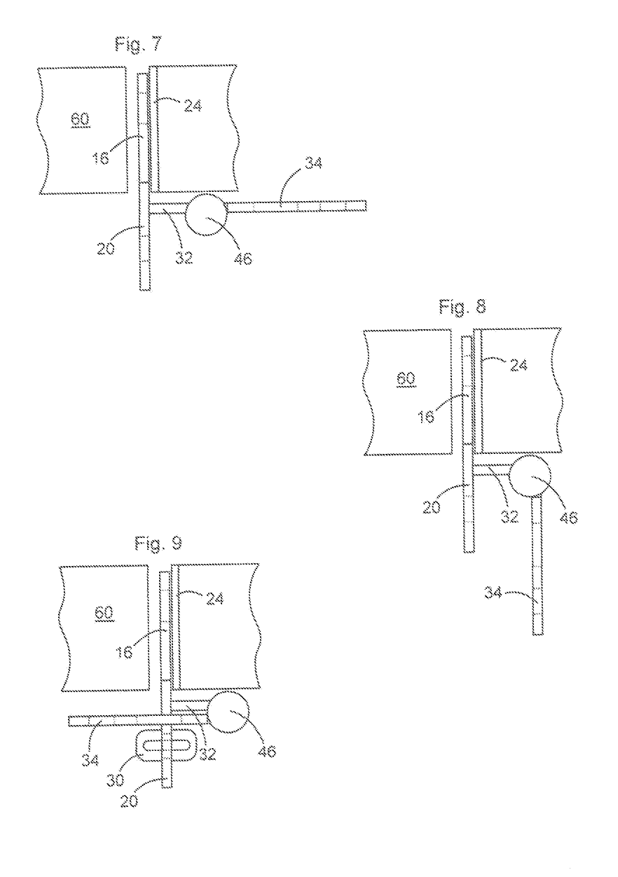

FIG. 8 is a top view of the lock with, the lock in the partially unlocked position.

FIG. 9 is a top view of the lock with the lock in the hill locked position.

In the following description, terms such as horizontal upright, vertical, above, below, beneath, and the like, are used solely for the purpose of clarity in illustrating the invention, and should not be taken as words of limitation. The drawings are for the purpose of illustrating the invention, and are not intended to be to scale.

As illustrated in the appended drawings, temporary lock, generally 10, is comprised of a jamb plate, generally 12, and a latching member, generally 14. One-piece jamb plate 12 includes a jamb attachment section 16 and a latch extension 20, which are in a common vertical plane. Attachment section 16 includes screw boles 22 for attaching jamb plate 12 to a door latch jamb 24. Extension 20 includes a pair of spaced, vertically aligned holes 26 sized to receive the shank of a padlock 30.

Latching member 14 is comprised of a vertically oriented connection plate 32 and a bitching plate 34. Connection plate 32 is attached perpendicularly at a first edge to the latch jamb side of extension 20 intermediate attachment section 16 and boles 26. Connection plate 32 also includes a hinged end 34 that includes spaced cylindrical knuckles 36. Latching plate 34 includes a hinged end 40 with spaced cylindrical knuckles 42 that interlock with knuckles 36 and are held together by pin 44 to form barrel hinge 46. Latch plate 34 also includes a vertically oriented opening 50 sized for insertion over the end of extension 20.

Temporary lock 10 is attached by attachment section 16 to latch jamb 24 with the front edge of latch extension 20 extending outwardly beyond jamb 24. Latching plate 34 is pivoted about barrel hinge 46 to an unlocked position. Door 60 can then be closed. To prevent door 60 from being opened, latching plate 34 is pivoted to its locked position, winch inserts the end of extension 20 through opening 50 with latching plate 34 projecting in front of and into the pathway of door 60. The shank of padlock 30 is then inserted through one of padlock holes 26 and padlock 30 is locked. If desired, two padlocks can be used, if opening of door 60 is attempted, the outer face of door 60 will strike latching plate 34. Holes 62 can he used to store padlocks when not in use.

Certain modifications and improvements will occur to those skilled in the an upon a reading of the foregoing description. It should he understood that all such modifications and improvements have been deleted herein for the sake of conciseness and readability but are properly within the scope of the following claims.

What is claimed is;

1. A temporary door lock for locking a door within the door opening of a door frame having a hinge jamb on one side of said frame to which said door is hinged and a latch iamb on the opposite side of said frame, said door being pivotal along a pathway between a closed position and an open position, comprising:
a) a jamb plate including an attachment section attachable to said latch jamb and an outwardly projecting latch extension having a front edge and an inner side toward said latch jamb; and
b) a latching member attached to dm inner side of said latch extension, said latching member including a latching plate with a latch opening pivotal between an unlocked position away from said door and a locked position in which the front edge of said latch extension extends through said latch opening and said latching plate extends into the pathway of said door preventing said door from pivoting to its open position.

2. The temporary door lock of claim 1, wherein said attachment section and latch extension, are integral and in a common plane.

3. The temporary door lock of claim 1, wherein door jamb includes screw holes and said attachment section includes holes spaced equal to said screw holes.

4. The temporary door lock of claim 1, wherein said latch extension includes at least one hole sized to receive a padlock shackle.

5. The temporary door lock of claim 1, wherein said latch opening is a vertically elongated slot.

6. The temporary door lock of claim 1, wherein said latching member includes a connector plate extending perpendicularly from said extension, said latching plate being hinged to said connector plate.

7. The temporary door lock of claim 1, wherein said attachment section has a height greater than the height of said latch extension.

8. The temporary door lock of claim 1, wherein said latching plate when in the closed position is perpendicular to said latch extension and is positioned between said attachment section and said latch extension forward edge.

9. The temporary door lock of claim 1, wherein said latching plate includes at least one hole for receiving a padlock shackle.

10. The temporary door lock of claim 1, wherein said latch extension is offset toward the latch jamb side of said opening when said latching plate is in the closed position.

11. A temporary door lock for locking a door within the door opening of a door frame having a hinge jamb on one side of said frame to which said door is hinged and a larch jamb on the opposite side of said frame, said door being pivotal along a pathway between a closed position and an open position, comprising:
a) a one-piece vertically aligned jamb plate including an attachment section and an outwardly projecting latch extension having a front edge, an inner side away from, said door opening, and a hole sized to receive a padlock shackle, said attachment section and latch extension being in a common plane; and
b) a latching member attached to the inner side of said latch extension, said latching member including a latching plate with a vertically elongated latch opening pivotal between an unlocked position away from said door and a locked position m which said latch extension if out edge extends through, said latch opening and said latching plate extends into the pathway of said door preventing said door from pivoting to Its open position.

12. The temporary door lock of claim L wherein door jamb includes strike plate screw holes and said attachment section includes holes spaced equal to said screw holes.

13. The temporary door lock of claim 11, wherein said latching member includes a connector plate extending perpendicularly from said extension, said latching plate being lunged to said connector plate.

14. The temporary door lock of claim 11, wherein said attachment section has a height greater than the height of said latch extension.

15. The temporary door lock of claim 11, wherein said latching plate when in the closed position is perpendicular to said latch extension and is positioned between said-attachment section and said padlock shackle opening.

16. The temporary door lock of claim 11, wherein said latch extension is offset toward the latch jamb side of said opening when said latching plate is in the closed position.

17. A temporary door lock for locking a door within the door opening of a door frame having a hinge jamb on one side of said frame to which said door is hinged and a latch jamb on the opposite side of said frame, said door being pivotal along a pathway between a closed position and an open position, comprising:
a) a one-piece vertically aligned jamb plate including an attachment section attachable to said latch jamb and an outwardly projecting latch extension having a front edge, an inner side away from said door opening, and a hole sized to receive a padlock shackle, said attachment section and latch extension being in a common plane; and
b) a latching member attached to the inner side of said latch extension, said latching member including a connector plate extending perpendicularly from the inner side of said vertical locking extension and a latching plate with a vertically elongated latch opening hinged to said connector plate and pivotal between an unlocked position away from said door and a locked position in which said latch extension extends through said latch opening and said latching plate extends into the pathway of said door preventing said door from pivoting to its open position.

18. The temporary door lock of claim 17, wherein said latching plate when in the closed position is perpendicular to said latch extension and is positioned between said attachment section and said padlock shackle opening.

19. The temporary door lock of claim 18, wherein said latch extension is offset toward the latch jamb side of said opening when said latching plate is in the closed position.

20. The temporary door lock of claim 18, wherein said connector plate and said latch plate are joined by a barrel hinge formed by interlocking knuckles on said connector plate and said latch plate.
